(19) United States
(12) Patent Application Publication
(10) Pub. No.: US 2007/0264618 A1
(43) Pub. Date: Nov. 15, 2007

(54) THREE-DIMENSIONAL EARTH SCIENCE DISPLAY DEVICE

(76) Inventor: Caryl Fuller, Oak Harbor, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/382,369

(22) Filed: May 9, 2006

(51) Int. Cl. G09B 27/08

(52) U.S. Cl. 434/131

(57) ABSTRACT

A three-dimensional display assembly conveying Earth science information. In the current bottom, the display assembly is a series of interconnected inset spherical layers which represent the inner and outer layers of the Earth. The layers are constructed of in the current embodiment, a foam like material which provides for ease construction and displaying various Earth information such as geographic information, rock formations landmasses etc. On the outer surface of the Earth's crust, the continents and oceans are represented in graphical format by imprinting images on series of polyvinyl chloride sheeting which configures to the curvature of the sphere. The inner spheres are accessible to look into the various layers of the Earth by taking the top hemisphere of the outermost layer off. This is done by removing a securing device which in the current bottom is a latch laid flush with the top surface of the sphere.

### BACKGROUND OF THE INVENTION

a) Field of the Invention

The current concept relates to the display of earth science information for educational and recreational purposes. It is particularly designed to relate various stratified earth layer information as well as geographic information either physical or human.

b) Background Art

U.S. Pat. No. 2,957,251 (Nystad et al) discloses an educational jigsaw globe puzzle; the puzzle is in the shape of a spherical globe. The jigsaw pieces themselves are portions of the spherical shape and are shell sections representing various geographic locations and can be secured to the frame of the globe. The globe is supported on a circular base and rotates on a pin. The globe has two semicircle sections or shells including a lower shell and an upper shell. The upper and lower sections are formed with a plurality of vertically and horizontally spaced elongated rectangular-shaped vertically disposed slots radiating from the North Pole to the South Pole and respectively, along vertical curved lines in simulation to the lines of longitude on the map. On the rear face of each segment of the jigsaw puzzle there is a fastening element comprising either a rectangular plate or strip of spring metal to provide a spring clip. The object of the game is to match the pieces and align them correctly to complete the globe.

U.S. Pat. No. 2,987,318 (Hammer) discloses a three-dimensional jigsaw puzzle which seems to be in one format the shape of a globe. The globe pieces or puzzle pieces are shaped in a curve to provide various indicational characteristics to provide for a particular shape such as a person's head or a globe. The puzzle pieces are curved along the arc of the outer surface and are provided with notches corresponding with projections to inner fit and lock together with the other puzzle pieces. A main central body has diametric sockets which accept pegs extending inwardly from the puzzle piece.

U.S. Pat. No. 4,494,935 (Miller) discloses a multipurpose globe, the globe has a series of detachable members or pieces which represent land masses, continents, countries, each having topographical or topological features, the topological features being detachable from the flat pieces, themselves detachable from the base globe section.

U.S. Pat. No. 4,865,323 (Heusdinkveld) discloses a spherical puzzle which has a three-dimensional sliding element with the surface of the puzzle in a spherical shape. The sphere is divided into longitudinal segments and latitudinal bands of surface elements. The puzzle can be solved by rearranging the surface elements by rotating the hemispherical sets of the longitudinal segments and the lateral or latitudinal bands. The elements have a pattern, color or numeric coding indicating the arrangement for the solution set.

U.S. Pat. No. 5,217,226 (Christopher) discloses a three-dimensional model atmosphere puzzle. The 3-D puzzle pieces can create model atmospheres for model globes and flat puzzles, the pieces have thicknesses suitable to include all types of subject matter imbedded within the pieces displaying the information in three-dimensional forms. The information includes geography, atmosphere, clouds, storm systems, and objects in flight, volcanic eruptions, nuclear explosions, and events of historical importance. The pieces can be updated after specific natural or man-made events.

U.S. Pat. No. 5,441,261 (Margolis et al) discloses a magnetic globe puzzle having plural puzzle layers and globe stand, the globe is rotationally molded of iron particles and a plastisol of polyvinyl chloride and has embossed on it from the mold, lines representing latitude and longitude. Two or more layers of magnetized puzzle pieces are included with printing on their faces which are thermoplastic sheets which are then die cut. There are multiple layers, the first layer containing Continental, longitude and latitude information, the second layer includes geologic features, and the third layer includes political information.

U.S. Pat. No. 5,667,550 (Giamportone et al) discloses a plate tectonic earth planet model, the model is based on plate tectonics and includes a number of curved members each representing one of earth's first crustal tectonic plates. Each plate member is formed of a durable lightweight plastic material molded, raised and indented to illustrate the tectonic features and subduction zones, collision zones, mid-ocean ridges, island chains, island arcs, continental shelves, terrestrial and ocean floor topography, and other similar features. The base of the globe is made of a plurality of spheroidal members including an inner core, an outer core, and a mantle, each representing the earth's strata layers. The plates form the exterior of the globe and represent the lithosphere. The inner core, outer core, and mantle are constructed of hemispherical portions and sit each one within the other.

U.S. Pat. No. 5,931,677 (Rifat et al) discloses an educational globe tool; the tool has a rigid spherical shape with a plurality of bores formed within the sphere and a lamp and switch associated with the sphere which generates an activation signal when closed. For the surface of the globe, a plurality of country pieces, each has an outboard portion and shape of the various countries. Each country piece has a post to remove and couple with one of the bores, which closes the switch of the circuitry. Control circuitry is adapted to illuminate one of the lamps for the various countries.

U.S. Pat. No. 6,464,502 (Munekata) discloses a three-dimensional intra-globe model, the globe has a series of concentrically arranged spheres made up of a transparent material, except for the innermost sphere, as well as the three-dimensional display members, which are arranged in spaces between the spheres and represent the physically continuous internal structure of the earth. The spheres are hemispherical, each main sphere having an upper section and a lower section as well as a gasket member of sorts which allows the hemisphere to connect to one another as well as the outer sphere being able to connect to the inner sphere for support and positioning in the spherical configuration. The spheres correspond to the various mantles of the earth and outer layer of the earth as well.

EP 0054,577 (Launzel) is a European patent application which discloses a three-dimensional puzzle. The puzzle has matching pieces each having a flat base and forms a tabular surface when pieces are matched. The pieces have contoured surfaces to generate a sculptured three-dimensional effect. The puzzle may be in the form of a subject of a single aggregation of pieces or a form connected independent pieces as in the case of connected hemispheres.

GB 2,185,844 (Crosbie) discloses a globe puzzle which has a sphere and the subsurface as well as an upper surface. The upper surface has two parts, the first part fixed on to the subsurface, which depicts the oceans of the earth and a second part.

PCT/AU004/01148 discloses a globe having flexible pieces attached to it. The globe has a sphere, which is set on a mount and is rotatable; a number of flexible sheet members are attached to the sphere. Pieces can be interlocking jigsaw pieces or they may be magnetically attached to the globe. This is useful as a puzzle, as well as a teaching aid.

### BRIEF DESCRIPTION OF THE DRAWINGS

FIG. 1 is a perspective view of the earth science display device;

FIG. 2 is a perspective view of the earth science display device with a top layer removed disclosing a detailed second layer sheet;

FIG. 3 is a perspective view of the earth science display device with a first and second detailed layer removed disclosing a third detailed layer sheet;

FIG. 4 is a cross-sectional view of the earth science display device;

FIG. 5A is an elevational view of the securing device;

FIG. 5B is a plan view of the securing device connecting a lower hemisphere to an upper hemisphere;

FIG. 5C is an elevational side view of the securing device;

FIG. 6 is an elevational side view of concentrically aligned stratified sphere layer arrangement.

### DETAILED DESCRIPTION OF THE PREFERRED EMBODIMENTS

In order to fully describe the present embodiment, an understanding of earth science information will be discussed. This discussion will lay the foundation for the terminology in the application.

Generally speaking, earth science (also known as geoscience), is an all embracing concept which relates to areas dealing with the planet Earth. The main areas within earth science include physics, geography, mathematics, chemistry, and biology. These areas are used to build a complete and comprehensive understanding of the main spheres of the earth system.

The earth's spheres include the areas of geology, soil science, oceanography or hydrology, the atmospheric sciences, and glaciology.

The main physical spherical layers of the globe or earth starting with the innermost region include: the inner core, the outer core, the mantle, the upper mantle, the lithosphere (including the crust), and the atmosphere. The atmosphere itself has many different layers which include from the outermost and working inwards, the exosphere, the thermosphere, the mesosphere, the stratosphere, and the treposphere.

The crust or more specifically the continental crust is included within the lithosphere. The lithosphere includes the continental crust plus the rigid upper mantle and the oceanic crust. With regard to dimensions, the oceanic crust located underneath the earth's oceans are generally between 5-10 km thick and are composed of primarily dark dense rock called basalt, while the continental crust is 20-70 km thick and is composed of a variety of less dense material.

Just below the lithosphere and rigid upper mantle portion, is the lower part of the upper mantle, which exhibits plastic-flowing properties. As previously mentioned, the upper mantle surrounds the mantle, which in turn surrounds the outer core and itself surrounds the inner core.

Located on the top layer of the crust, the ocean as well as the continents and the atmosphere make up the geography which directly affects human kind. Geography is loosely defined as the study of location and spatial variations in both the natural realm and the human realm located on and/or within the earth. This generally occurs at the intersection between the lithosphere and the atmosphere. Geography covers a wide range of disciplines and may vary depending on the particular researcher's interests. This range includes areas such as biology to economics, sociology, psychology, sports, politics, geology, and others.

Physical geography, which focuses on geography as an earth science, aims to understand the layout of the earth and its weather, geology patterns, sediment movement, and hydrologic movement. Geography in the physical sense can be divided into geomorphology, hydrology, glaciology, biogeographic, climatology, pedology, coastal marine studies, geodesy, palaeogeography, environmental geography, ecology, as well as oceanography to name a few. Many times these physiogeography areas can be related to continents, deserts, islands, land forms, oceans, seas, rivers, lakes, soils, geographic timelines, paleontology, ecology, geostatistics, environmental sciences, oceanography, weather patterns and environmental studies.

In addition to physical geography, human geography is another well studied and familiar concept. This branch of geography focuses on the human patterns and processes that interact with various physical environments. These include: human, political, cultural, social, and economic aspects of human existence and/or growth on the earth. These areas can be broken into other subcategories such as economics, growth or development, populations, urban locations, social locations, behavioral locations, cultural locations, political boundaries, historical geography, regional geography, strategic geography, military, and others.

The present concept shows stratifications of the crust and/or top layer, such as an atmosphere which may be in one form clear plastic having a certain thickness to it with various weather pattern data information showing on or in it. Additionally on the sphere just below the atmosphere, the continental crust or what is technically referred to as the lithosphere might show the geographic relief information as well as the continental information or the country political boundaries as is commonly referred to.

Nonetheless, the showing of this information is one portion of the overall concept; the second portion is the way that the layers and in the current embodiment, sphere layers, are held within one another. For example, the atmosphere may be the outer layer, or outer sphere, and then the crust or lithosphere may be the second spherical layer. In one particular embodiment, each of the spheres are disassembled into hemispheres, enabling the spheres to sit one within the other and to be contained within one another. To keep the individual hemispheres together, a locking or connecting/coupling mechanism of some sort is used to nearly seamlessly connect the upper atmosphere to the lower atmosphere of each of the layers of the earth.

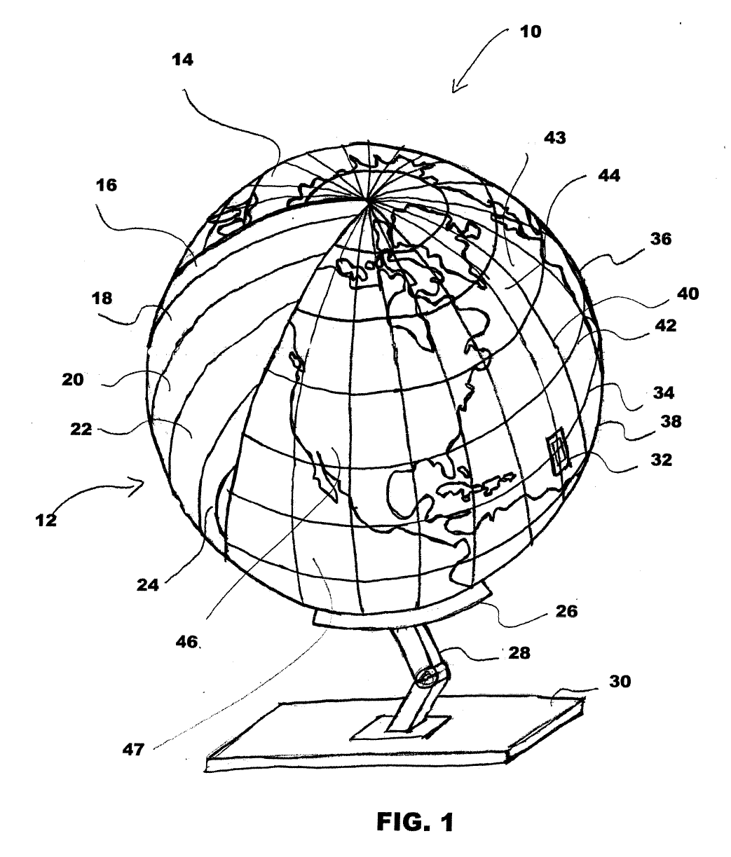

With this brief understanding of overall earth science information display device, we will now discuss in more detail the current embodiment of the present concept. Referring to FIG. 1, an earth science display device 10 is shown in the current embodiment as an earth globe. Other types of display devices can be used to convey similar type information as will be discussed below. These other arrangements include in lieu of a globe-type surface, a flat Cartesian map-type surface or other suitable way of disclosing the earth science information, such as the atmosphere, crust, upper mantle, mantle, outer core, and inner core of the physical earth geography.

In the current embodiment, the earth science display device or globe 10 is shown with a cutaway section which discloses the various layers 12 of the earth's stratification. The cutaway section is shown for illustration purposes, and the globe itself would be a complete sphere.

The layers displayed in the current embodiment include an atmosphere 14, a crust 16, an upper mantle 18, a mantle 20, an outer core 22, and an inner core 24. Much of the human relevant geographic information will be displayed within the atmosphere 14 as well as the outer surface of the crust 16. For example, the continents 46 as well as the oceans 47, various weather patterns, geologic features, political boundaries and the like as discussed in the above earth science information will be provided on the outer surface of the crust 16. This information is disclosed in current embodiment with pliant polyvinyl chloride film or sheeting 44. The PVC sheeting 44 is in one embodiment 5 mil thick but can be various thicknesses to conform to display perameters. The general nature of the PVC sheeting allows thin sheets to stick together in layers through a combination of surface viscosity and/or static electricity.

Also, the sheeting 44 or information containing component can be arranged in various configurations to display the information on the globe 10. For example, the PVC sheeting 44 can be arranged in quadrants 43, the quadrants divided into predetermined areas by the longitude 42 and latitude 40 lines which help to map out the earth globe 10. Other ways of dividing up the PVC sheeting 44 include by either physical geographic information or human geographic information. Additionally, the pieces can be configured as puzzle pieces, having more of a rigid configuration and fitting or interlocking one within the other. For example, the sheeting 44 could be divided into physical geographic pieces arranged to display certain portions of environmental geographic regions.

This physical geographic representation will be in the form of oceans, seas, rivers, lakes, islands, and land forms which deal with various environmental issues.

The PVC sheeting 44 can be pieced together so that one portion of the, for example, Indian Ocean can be taken away from the globe 10 and another portion of the Indian Ocean would still be in its place.

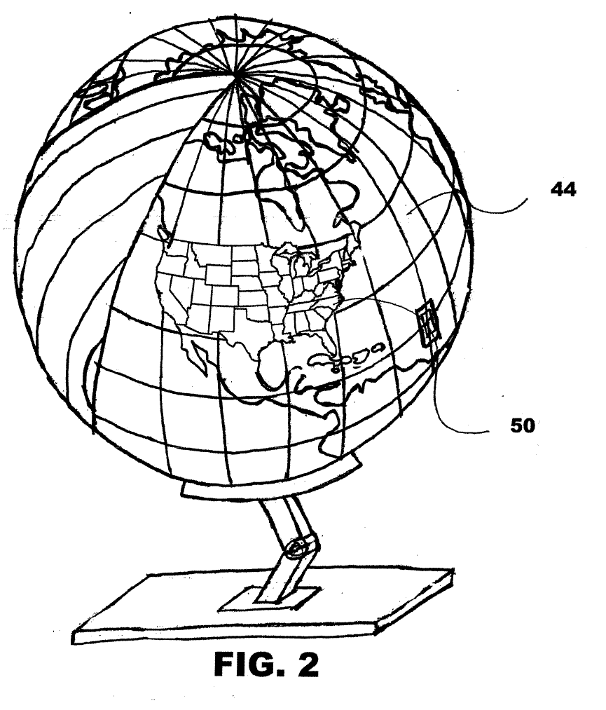

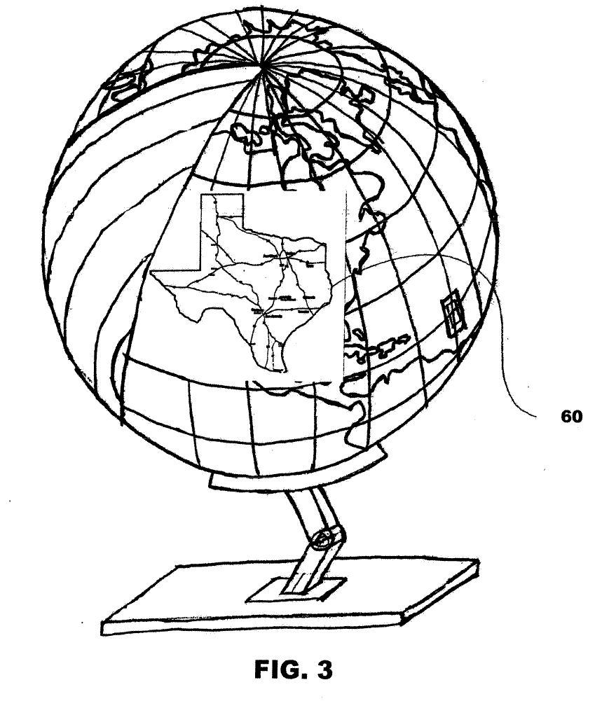

Additionally, human geographic information can be disclosed such as political boundary areas. FIG. 2 discloses the political boundary areas of the United States which is a detailed sheet 50 of the 48 Continental states. In one form, the pliant PVC top sheet 44 is removed and a second layered, more detailed political boundary area sheet 50 showing the individual political states is shown for more detailed information. In an alternative format, the political states may be interlocked with one another through the previously-mentioned puzzle pieces configuration. Still referring to FIG. 2, if the person studying the geographic information on the globe 10 has an interest in learning more about for example a marker indicated state, he may remove the 2^{nd} top layer 50 to disclose the enlarged information. For example, referring to FIG. 3, after removing the second sheet 50 showing the political boundaries of the United States, a larger more detailed third layer 60 showing the State of Texas with its roadmap system is disclosed.

Referring back to FIG. 1, as previously mentioned, the globe 10 has a plurality of stratified layers 12. These layers are represented in spherical format in the current embodiment. Thus the spheres themselves have an inner volume and surface and an outer surface with a layer thickness to provide for geologic information as well as structural rigidity and support. In order to access the lower layers or inner layers, such as the mantle or outer core 22, the spheres have been divided in the current embodiment into an upper hemisphere 36 and a lower hemisphere 38. For convenience sake, the upper hemisphere 36 is detachable from the lower hemisphere 38 at the equator line 34 by detaching or unlatching a securing device 32 which will be discussed below. Other hemispherical arrangements are envisioned.

Also, the globe itself can be seated on a base structure 30 which has a support arm 28 and a seat 26. This is for display purposes but could also be used to position the globe about its polar axis for display purposes. Other configurations for the support base 30 can be used, such as a low dish-shaped base, having an inner semispherical configuration to mate with the other spherical contour of the globe.

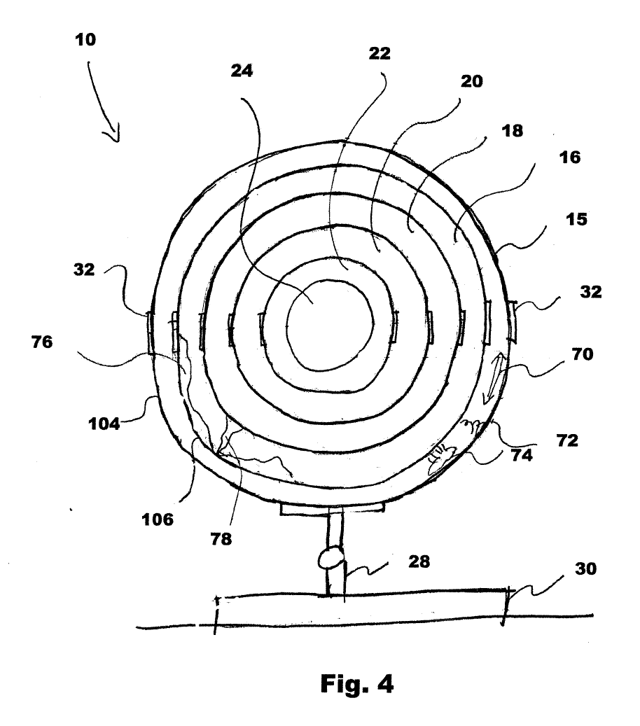

To further detail the arrangement of the various layers of the earth science display device 10, a discussion of how each sphere fits one within the other concentrically will now be provided. Referring to FIG. 4, the earth science display device 10 is shown in cross-section, with the spheres sitting concentrically one within the other. In order to provide for reasonable support, the interface between the larger outer sphere and the lesser diameter inner sphere is tight, thus avoiding jostling or erratic movement of the spheres within the confines of the globe 10. In order to create a tightly fit and compact set of spheres, the securing device 32 needs to be reasonably flush with the outer surface and inner surface of each of the spheres. This will be described below. In the current embodiment, an atmosphere 15 is the outer sphere which encases a crust sphere 16. This in turn encases the upper mantle sphere 18 which in turn encases mantle's sphere 20. The outer core sphere 22 encases the inner core sphere 24. To access the inner core sphere 24, the user would need to detach the securing device from the outer sphere layers and remove the top hemisphere or upper hemisphere 36 from each of the outer layers.

Discussing some of the display information which is provided on for example the outer atmosphere layer 15, a jet stream 70 is shown which is located within the atmosphere and also a weather pattern 72, various cloud formations 74, and other atmospheric fluid dynamics.

Within the crust sphere 16, various volcanic mountain ranges 78 are shown in geologic format including the ocean 76, and land masses as desired.

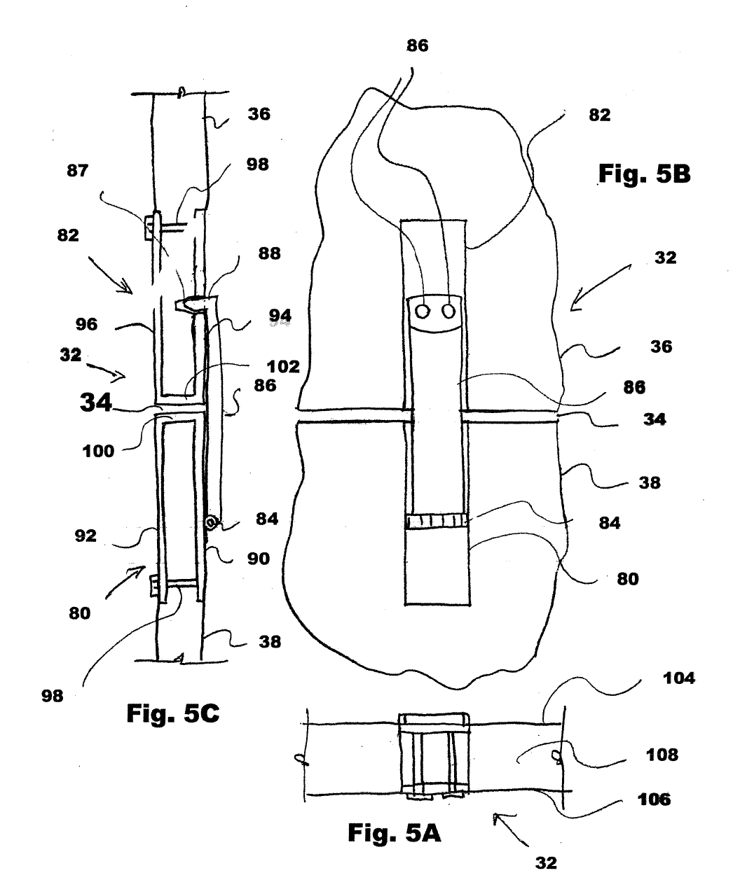

As previously mentioned, the securing device needs to be reasonably flush with the outer and inner surfaces of each sphere so as to provide a compact arrangement. Referring to FIGS. 5A, 5B and 5C, the securing device 32 in the current embodiment is shown as a hook and latch-type connection. Other type connections such as hook and loop type fasteners maybe used as well. To connect the upper hemisphere 36 to the lower hemisphere 38, the securing device 32 has a base 80, which has a base top plate 90, a base bottom plate 92 and a base edge plate 100. The base anchor is fashioned in somewhat of a cross-sectionally arranged U-format which acts as somewhat of a clip, and a connecting pin 98 attaches the base top plate 90 to the base bottom plate 92 at the vertically lower end of the base anchor 80.

Connected to the upper hemisphere 36 is the receiving anchor 82. The receiving anchor is arranged substantially the same as the base anchor 80, with the exception of a female receiving port 87. The female receiving port 87 is configured to accept male connection teeth 88, which are attached to a latch arm 86 which is hinged to the outer surface of the base anchor top plate 90. In one format the hinge is a spring-loaded hinge, in other formats the hinge is provided without a spring.

The receiving anchor 82 and the base anchor 80 clamp on to the hemispheres respectively and are longitudinally aligned so that the latch arm 86 can connect to the female connection ports. Referring briefly back to FIG. 4, each sphere has at least one securing device connecting the top hemisphere to the bottom hemisphere, but preferably two or more securing devices per spherical layer will be provided.

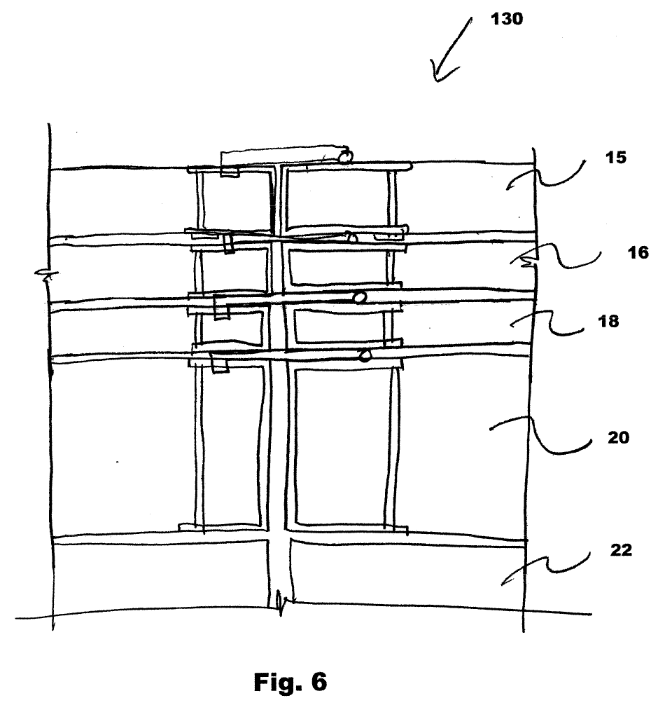

Thus when the hemispheres are connected to one another, and the sphere layers are placed in their desired arrangement, a compact concentrically aligned stratified sphere layer arrangement 130 is provided as seen in FIG. 6. The atmosphere layer 15 is within close interface contact with the crust layer 16 which in turn close interface contact with the upper mantle layer 18 which is in close contact with the mantle layer 20 which is in close contact with the outer core layer 22 and so on. In addition to the main stratification layers 12, thinner concentrically aligned sphere layers may be provided say for example at the atmosphere level 15. Thus the same arrangement and so construction as the previously mentioned main earth layers 12 could be provided for the exosphere, the thermosphere, the mesosphere, the stratosphere, and troposphere. Various types of earth information and atmospheric specific will be provided within these layers on the outer or inner surfaces of layers depending on the desired arrangement.

Therefore I claim:

1. An earth science display device to convey earth science information, said earth science display device comprising:
a. a plurality of strata layers, said strata layers each defining one or more variations of the earth's layers, said strata layers holding a plurality of information display components;
b. said plurality of information display components each conveying certain earth science information,
c. said earth science information comprising: physical earth information; mathematical earth information; geographical earth information; biological earth information; and chemical earth information; and,
d. the strata layers connected to one another by a plurality of securing devices; said strata layers detachable from one another by removing said securing devices.

2. The device according to claim 1 wherein said plurality of strata layers is configured in spherical layers.

3. The device according to claim 1 wherein said plurality of strata layers are configured in flat layers.

4. The device according to claim 2 wherein said plurality of spherical strata layers represent each layer of the earth.

5. The device according to claim 4 wherein said plurality of spherical strata layers further comprise: an atmosphere; a crust; and upper mental; a mental; and outer core; and an inner core.

6. The device according to claim 5 wherein said plurality of spherical strata layers are further configured with interior volume regions and arranged to seat one within another.

7. The device according to claim 2 wherein said plurality of spherical strata layers are each divided into hemispheres.

8. The device according to claim 7 wherein said hemispheres are connected to one another by said securing devices.

9. The device according to claim 2 wherein said plurality of spherical strata layers are further comprised of one or more following materials: foam, plastic, wood, metal.

10. The device according to claim 2 wherein said securing devices connect hemispheres of said plurality of spherical strata layers together, said securing devices further comprising: a base anchor connected to a first hemisphere and a receiving anchor connected to a second hemisphere, a latch pivoting from said base anchor and operably connected to said receiving anchor.

11. The device according to claim 2 wherein said securing devices are hook and loop fasteners to connect hemispheres of said plurality of spherical strata layers together.

12. The device according to claim 2 wherein said plurality of spherical strata layers further comprise a first spherical layer, a second spherical layer, and a plurality of intermediate spherical layers.

13. The device according to claim 12 wherein said first spherical layer is of a lesser diameter than said second spherical layer, said intermediate sphere layers having diameters greater than said first spherical layer but less than said second spherical layer.

14. The device according to claim 2 wherein said plurality of information display components is further comprised of pliant polyvinyl chloride sheeting, said earth science information recorded on said pliant polyvinyl chloride sheeting.

15. The device according to claim 14 wherein said plurality of information display components are arranged to represent various geographical earth information.

16. The device according to claim 15 wherein said geographical earth information comprises physical geography and human geography.

17. The device according to claim 2 wherein said plurality of information display components further comprises earth science information arranged in interlocking puzzle pieces.

18. An earth science display device to convey earth science information, said earth science display device comprising:
a. a plurality of strata layers comprising:
i. a first spherical strata layer having first top and bottom hemispheres detachable from one another;
ii. a second spherical strata layer having second top and bottom hemispheres detachable from one another;
iii. at least one intermediate spherical strata layer having intermediate top and bottom hemispheres detachable from one another;
b. said first spherical strata layer having a lesser diameter than said second spherical strata layer, said at least one intermediate spherical strata layer having a diameter greater than said first spherical strata layer and less than said second spherical strata layer, said second spherical strata layer arranged to encompass said at least one intermediate spherical strata layer, said at least one intermediate spherical strata layer arranged to encompass said first spherical strata layer;
c. said plurality of strata layers further comprising one or more variations of the earth's layers;
d. a plurality of securing devices to connect said top and bottom hemispheres of each strata layer to one another, said securing devices comprising:
i. a bottom anchor and a top anchor,
ii. a spring-loaded latch arm connected to the bottom anchor by a hinge,
iii. said bottom anchor and said top anchors both flush with the top surface of the respective top hemisphere and bottom hemisphere outer surfaces,
iv. said top anchor having a female receiving port to receive said spring-loaded latch arm to connect said bottom hemisphere to said top hemisphere;
e. a plurality of information display components conveying certain earth science information comprising:
i. physical earth information; mathematical earth information; geographical earth information; biological earth information; and chemical earth information; and,
ii. said plurality of information display components further comprised of a polyvinyl chloride sheeting material having a thickness of at least five mil and containing said earth science information.

19. A process for conveying three-dimensional earth science information, said process comprising:
a. arranging a plurality of stratified spherical earth layers concentrically within one another,
b. providing each of said stratified spherical earth layers with a first hemisphere, a second hemisphere, and at least one securing device to connect the first and second hemispheres together;
c. accessing the inner stratified spherical earth layers by performing an accessing process including:
i. disconnecting the securing device attached to the outermost stratified spherical earth layer;
ii. removing the first or second hemisphere of the outermost stratified spherical earth layer to display the next outermost stratified spherical earth layer; and,
iii. repeating the accessing process on the next outermost stratified spherical earth lawyer has desired.

20. The process according to claim 18 wherein said process for conveying three-dimensional group science information further comprises:
a. reversing said accessing process to enclose said stratified spherical earth layers within one another.
